(19) United States
(12) Patent Application Publication
(10) Pub. No.: US 2010/0162510 A1
(43) Pub. Date: Jul. 1, 2010

(54) ASSEMBLY FOR REMOVING DEBRIS FROM A WINDSHIELD

(76) Inventor: John H. Couch, Rochester Hills, MI (US)

Correspondence Address: HARNESS, DICKEY & PIERCE, P.L.C., P.O. BOX 828, BLOOMFIELD HILLS, MI, 48303, US

(21) Appl. No.: 12/721,000

(22) Filed: Mar. 10, 2010

Related U.S. Application Data
(63) Continuation of application No. 12/296,194, filed on Oct. 6, 2008.
Application No. 12/296,194 is a continuation-in-part of application No. 11/076,292, filed on Mar. 9, 2005.
Application No. 11/076,292 is a continuation-in-part of application No. PCT/US2003/028331, filed on Sep. 9, 2003.
Application No. PCT/US2003/028331 is a continuation of application No. 10/352,363, filed on Jan. 27, 2003, now Pat. No. 6,859,972.
(60) Provisional application No. 60/790,001, filed on Apr. 6, 2006.
(60) Provisional application No. 60/409,876, filed on Sep. 11, 2002.

(51) Int. Cl. B60S 1/02

(52) U.S. Cl. 15/250.3

(57) ABSTRACT

A wiper system for use with a windshield is provided and may include a housing, a wiper arm rotatably supported by the housing about a first pivot point between a first position proximate to the windshield and a second position raised from the windshield, and a separator assembly coupled to the housing and selectively moving the wiper arm from the first position to the second position. The wiper system may also include a biasing member biasing the wiper arm in the first position and a bracket extending from the housing to the biasing member to rotatably couple the biasing member to the housing at a second pivot point.

### CROSS-REFERENCE TO RELATED APPLICATIONS

This application is a continuation-in-part of U.S. application Ser. No. 12/296,194 filed 6 Oct. 2008, which is the National Stage of International Application No. PCT/US2007/008602 filed 5 Apr. 2007, which claims the benefit of U.S. Provisional Application No. 60/790,001 filed 6 Apr. 2006 and is a continuation-in-part of U.S. application Ser. No. 11/076,292 filed 9 Mar. 2005, which is a continuation-in-part of International Application No. PCT/US2003/028331 filed 9 Sep. 2003, which claims priority to U.S. application Ser. No. 10/352,363 filed 27 Jan. 2003 (now U.S. Pat. No. 6,859,972), which claims the benefit of U.S. Provisional Application No. 60/409,876 filed 11 Sep. 2002. The entire disclosures of each of the above applications are incorporated herein by reference.

### FIELD

The present disclosure relates to wiper assemblies and more particularly to a wiper assembly capable of removing debris trapped under a wiper with an inflatable air bladder.

### BACKGROUND

This section provides background information related to the present disclosure which is not necessarily prior art.

In using a windshield in either an automotive application or in other applications such as in boating, heavy machinery or the like, it is imperative that the operator be able to clearly see through the windshield to steer and maneuver the machine. Further, it is desirable that the operator be able to clearly see through the windshield in inclement weather conditions such as in rain, sleet, or snow. Further yet, it is desirable that the operator be able to remotely clean the windshield of foreign substances such as dirt, leaves, and other mire to maintain visibility. To that end, a windshield wiper system cooperating with an outer surface of a windshield plays a significant role.

Maintaining a clean windshield is crucial in the safe and responsible operation of a vehicle to ensure that the operator is able to clearly see and steer the vehicle through various weather and driving conditions. In this regard, a windshield wiper system is conventionally used to articulate back and forth across the windshield of a vehicle in an effort to wipe away moisture or debris, thereby providing the operator and other occupants with a clear sight path through the windshield.

Conventional wiper systems typically include a pair of arms rotatably driven by a wiper motor, whereby each arm includes a wiper blade in uniform contact with an outer surface of the windshield extending over a predetermined surface of the windshield. The wiper blade is conventionally fabricated from an elastomeric material, thereby allowing the blade to conform to the generally complex and curved shape of the windshield. The effectiveness of the wiper system is directly related to the ability of the wiper blade to maintain a uniform contact with the windshield throughout the region of the predetermined surface such that water can be effectively trapped between the blade and the windshield and ultimately removed through articulation of the arms.

The wiper motor serves to articulate the arms across the predetermined surface in an effort to clean the windshield and improve visibility. The sweeping motion of the wiper arms catches debris collected on an outer surface of the windshield and serves to move the debris to an outer edge thereof. In doing so, the wiper arms effectively move debris out of the line of vision of the operator and other occupants, thereby improving visibility. In this manner, larger objects such as leaves or pine cones are caught by the arm and are moved to the side of the windshield through the back and forth movement of each arm. For water and other smaller objects such as pine needles or bugs, the wiper blade contacts the object and serves to move or push the debris to the sides of the windshield. In either situation, the debris is often removed by the forward movement of the vehicle in cooperation with the movement of the arms such that the wind rushing over the windshield removes the debris all together.

The operation of the wiper system is hindered when debris is collected under the wiper blade, thereby preventing a uniform engagement between the wiper blade and the windshield. In this manner, the wiper system cannot function properly when debris is trapped between the wiper blade and the windshield as water cannot effectively be trapped between the wiper blade and the windshield when the blade is locally removed from contact with the windshield by debris. By hindering the operation of the wiper assembly, debris trapped between the wiper blade and the windshield makes operation of the vehicle difficult as visibility through the windshield is reduced.

In addition to debris, collection of frozen water between the blade and the windshield in the form of ice or slush similarly causes the blade to locally disengage the windshield, thereby hindering operation of the wiper system. In addition to locally lifting the wiper blade from contact with the windshield, the temperature of the ice or slush often hardens the wiper blade, thereby not allowing the blade to conform to the shape of the windshield. Further, the hardening of the ice or slush may even freeze the blade in one position such that the motor cannot rotate the arms. In any event, the operator is often required to remove the debris from under the blade by lifting the blade from contact with the windshield and manually removing the debris. In the case of frozen water or slush, the operator is often required to quickly lift the blade from contact with the windshield and allow the blade to snap back, thereby dislodging any ice or snow from the blade.

Conventional wiper systems have been modified to incorporate debris removing systems, operating on the principal that by lifting the wiper arm and removing the wiper blade from contact with the windshield, the debris collected between the wiper blade and the windshield will be released, thereby allowing the debris to be removed by a rush of air caused by the forward movement of the vehicle. Such systems, while adequately lifting the wiper blade from contact with the windshield, typically require interaction with an apparatus mounted on an external surface of the vehicle such as a ramp or a lift. In this manner, the lift or the ramp is visible on the exterior of the vehicle whether the wiper system is in use or not, thereby reducing the overall aesthetics of the vehicle and increasing drag over the windshield.

Commonly assigned U.S. Pat. No. 6,859,972 and U.S. Publication No. 2005-0155174-A1 are generally directed to wiper assemblies for removing debris trapped under a wiper. U.S. Pat. No. 6,859,972 and U.S. Publication No. 2005-0155174-A1 are incorporated by reference as if fully set forth herein.

A continuous need for improvement of the pertinent art remains.

### SUMMARY

This section provides a general summary of the disclosure, and is not a comprehensive disclosure of its full scope or all of its features.

A wiper system for use with a windshield is provided and may include a housing, a wiper arm rotatably supported by the housing about a first pivot point between a first position proximate to the windshield and a second position raised from the windshield, and a separator assembly coupled to the housing and selectively moving the wiper arm from the first position to the second position. The wiper system may also include a biasing member biasing the wiper arm in the first position and a bracket extending from the housing to the biasing member to rotatably couple the biasing member to the housing at a second pivot point.

In another configuration, a wiper system for use with a windshield is provided and may include a housing, a wiper arm rotatably supported by the housing between a first position proximate to the windshield and a second position raised from the windshield, and a separator assembly coupled to the housing and selectively moving the wiper arm from the first position to the second position. The wiper system may also include a biasing member biasing the wiper arm in the first position and a bracket rotatably coupled to the housing at a first end and attached to the biasing member at a second end.

Further areas of applicability of the present teachings will become apparent from the detailed description provided hereinafter. It should be understood that the detailed description and specific examples, while indicating the certain embodiments, are intended for purposes of illustration only and are not intended to limit the scope of the present teachings.

### DRAWINGS

The drawings described herein are for illustrative purposes only of selected embodiments and not all possible implementations, and are not intended to limit the scope of the present disclosure.

FIG. 1 is a perspective view of a wiper assembly for a motor vehicle in accordance with the present teachings.

FIG. 2 a side view of a portion of the wiper assembly in accordance with the present teachings, the wiper blade of the wiper assembly shown oriented to a normal use position.

FIG. 3 is a view similar to FIG. 2, illustrating the wiper blade in accordance with the present teachings articulated to a position displaced from a windshield.

FIG. 3A is another view similar to FIG. 2, illustrating another wiper assembly for a motor vehicle in accordance with the present teachings.

FIG. 4 is a partially exploded side view of the wiper assembly in accordance with the present teachings.

FIG. 5 is a perspective view of a base member of the wiper assembly in accordance with the present teachings.

FIG. 6 is another perspective view of a base member of the wiper assembly in accordance with the present teachings.

FIG. 7 is a cross-sectional view taken along the line 7-7 of FIG. 5.

FIG. 8 is a side view of a wiper assembly in accordance with the present teachings.

FIG. 9 is a side view of the wiper assembly of FIG. 8.

FIG. 10 is a bottom view of the wiper assembly of FIG. 8.

FIG. 11 is an exploded view of the wiper assembly of FIG. 8.

FIG. 12 is a side view of a wiper assembly in accordance with the principles of the present teachings.

FIG. 13 is a side view of the wiper assembly of FIG. 12 in an actuated state displaced from a windshield of a vehicle.

Corresponding reference numerals indicate corresponding parts throughout the several views of the drawings.

### DETAILED DESCRIPTION

Example embodiments will now be described more fully with reference to the accompanying drawings.

The following description is merely exemplary in nature and is not intended to limit the present disclosure, application, or uses. It should be understood that throughout the drawings, corresponding reference numerals indicate like or corresponding parts and features.

With reference to the drawings, a wiper system in accordance with the present teachings is illustrated and generally identified at reference character 10. The wiper assembly 10 is illustrated to generally include a separator assembly 12, a wiper arm 14, a linkage 16 and a wiper blade 18. To the extent not otherwise described herein, it will be understood that the wiper arm 14, the linkage 16 and the wiper blade 18 are conventional in construction insofar as the present teachings are concerned.

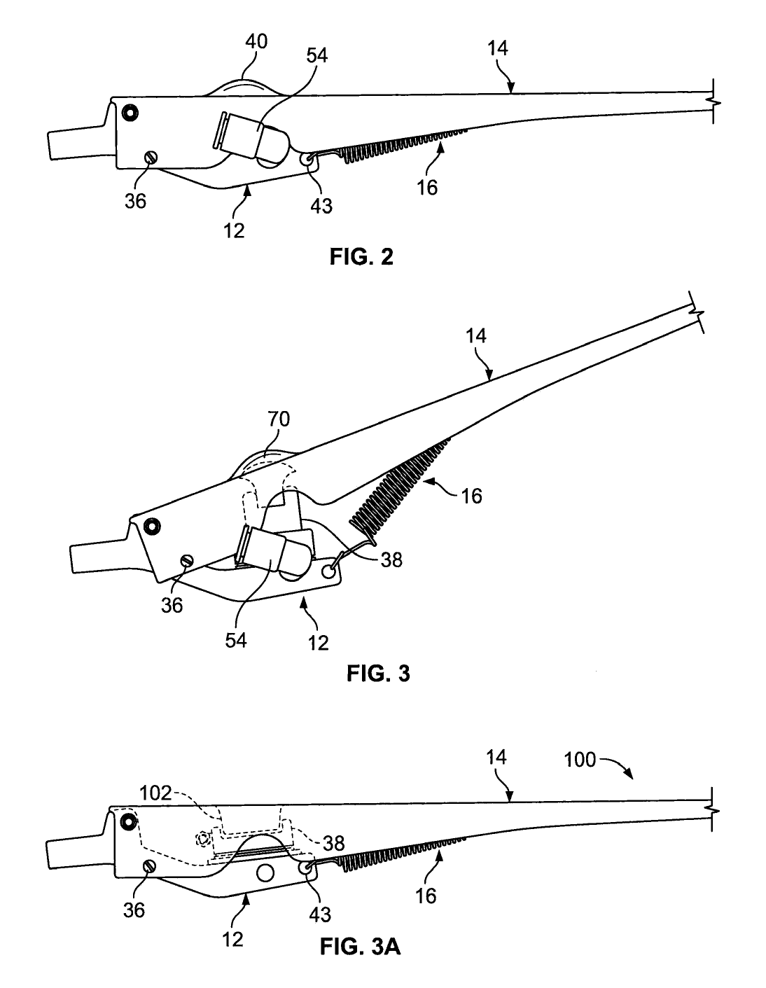

FIG. 2 illustrates the wiper arm 14 and wiper blade 18 oriented in a normal use position or lowered position. In this normal use position, the wiper blade 18 may be positioned adjacent a windshield (not shown) for normal cleaning of the windshield. FIG. 3 illustrates the wiper arm 14 and wiper blade 18 articulated to a raised position. In the raised position, the wiper blade 18 may be upwardly displaced from windshield against a conventional biasing force imparted by the linkage 16. As will be appreciated more fully below, the wiper arm 14 and wiper blade 18 may be quickly and repeatedly raised and lowered such that the wiper blade 18 is slapped against the windshield to facilitate the removal of debris. Such debris may include, but is not limited to, ice, leaves, paper, and the like.

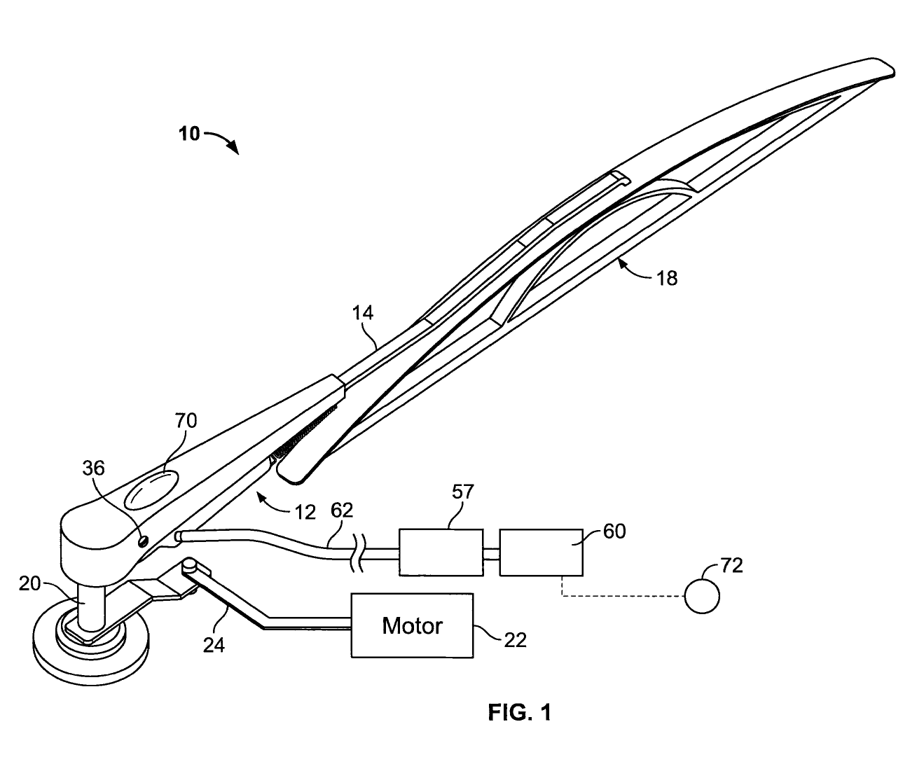

As shown in the perspective view of FIG. 1, the wiper assembly 10 may be driven by an output shaft 20 of a conventional motor vehicle wiper system. The output shaft 20 may be connected to a motor 22 through a linkage 24. The particular arrangement shown in FIG. 1 should be understood to be exemplary in nature. In this regard, the wiper assembly 10 in accordance with the present teachings may be readily adapted to be used with various conventional wiper system drive arrangements.

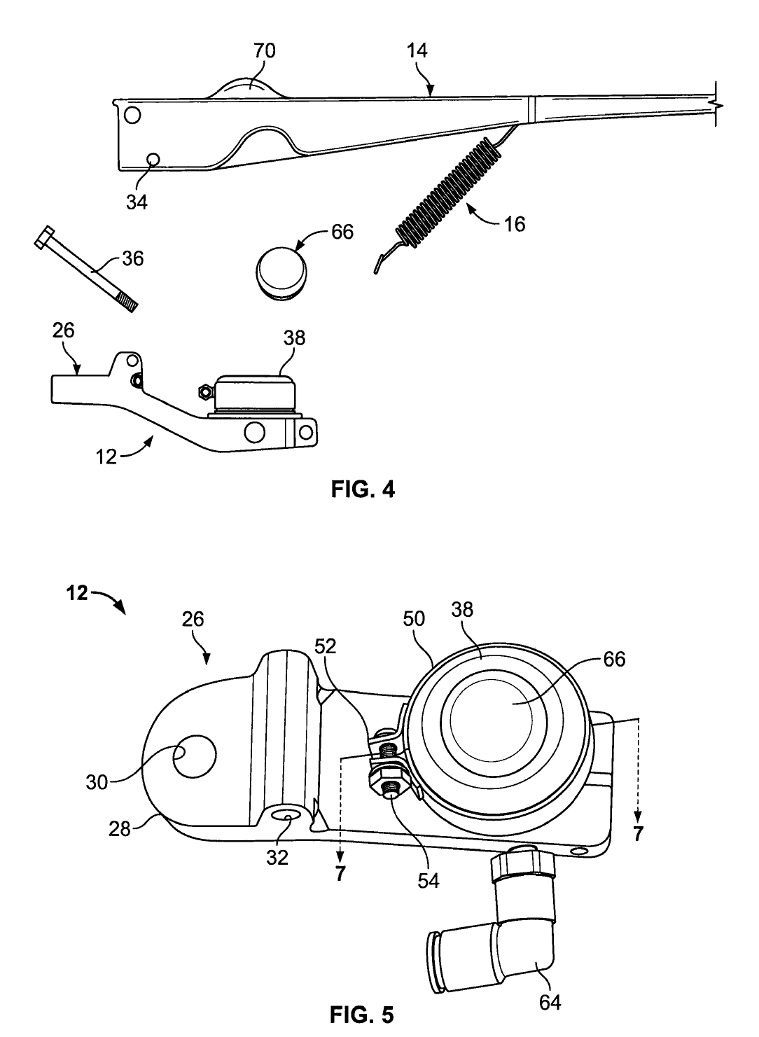

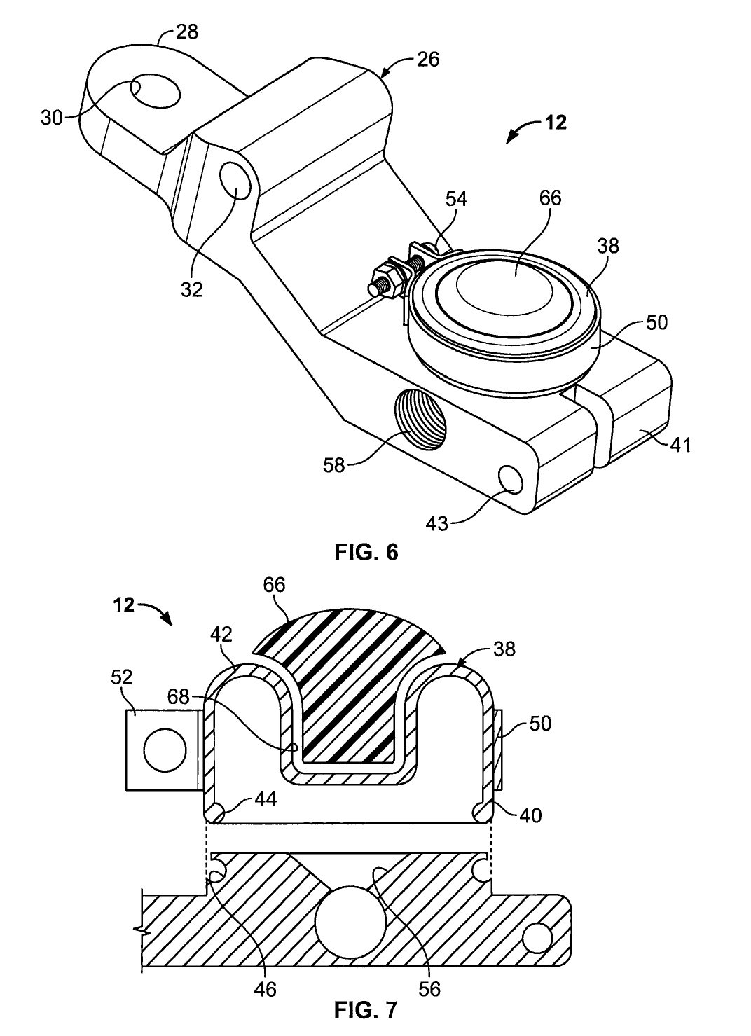

The separator assembly 12 may include a base or base portion 26. The base 26 may have a first end 28 for mounting to the output shaft 20 of the motor vehicle wiper system. The first end may define an aperture 30 (see FIGS. 5 and 6, for example) for receiving an output shaft of the conventional wiper system. In this manner, the wiper assembly 10 may be readily retrofit to existing vehicles. The base 26 may be secured to the output shaft 20 in any manner well known in the art. For example, while not particularly illustrated, the base 26 may define a threaded hole in communication with the aperture 30. As shown in FIGS. 4 and 5, for example, the base 26 may include one or more threaded holes that may receive set screws (not particularly shown) for quick and secure attachment of the base 26 to the output shaft 20. Alternatively, the base 26 may be clamped or otherwise secured to the output shaft 20. In these and other manners, the wiper assembly 10 may be mounted for rotation with the output shaft 20 about an axis defined by the output shaft 20.

The base 26 may be adapted to attachment to the wiper arm 14 such that the wiper arm 14 may be rotated about an axis relative to the base 26. The axis about which the wiper arm 14 may be rotated may be perpendicular to the axis defined by the output shaft 20. As illustrated, the base 26 may define a through bore 32 adapted to align with cooperating openings 34 in the wiper arm 14. The bore 32 and openings 34 may receive a fastener or pin 36. The fastener 36 may threadably engage a nut for securement of the wiper arm 14 to the base 26.

A second end of the base 26 may carry at least one bladder 38. While not visible in FIG. 2, it will be understood that the bladder 38 is in a relaxed position or deflated condition in FIG. 2. The bladder 38 is similarly in the relaxed position in FIGS. 4-7. FIG. 3 illustrates the bladder 38 in an extended position or inflated condition. In the extended position, the bladder 38 may serve to articulate the wiper arm 14 and wiper blade 18 from the lowered position of FIG. 2 to the raised position of FIG. 3.

The bladder 38 may be domed shaped and include a lower portion 40 for attachment to the base 26 and an upper portion 42 for displacing the wiper arm 14. As shown in the drawings, the bladder 38 may be secured proximate a second end 41 of the base 26. The lower portion 40 may be generally cylindrical. As shown particularly in the cross-sectional view of FIG. 7, the lower portion 40 may include a mounting structure 42. The mounting structure may define an inwardly extending circumferential flange 42. The flange 42 may be generally cylindrical and may be received within a corresponding circumferentially extending opening 44 defined by an upwardly extending wall 48 of the base 26.

A clamp 50 may surround the lower portion 40 and secure the bladder 38 to the base 26. The clamp 50 may define a pair of flanges 52. The flanges 52 may define openings for receiving a fastener 54. As shown perhaps most clearly in FIG. 5, the clamp 50 may include a ring and a pair of mounting flanges 52 welded or otherwise secured to the ring. The ring is adapted to completely or at least substantially completely surround the bladder 38. The ring may be an open ring having opposing ends. Once positioned about the bladder 38, the fastener 54 is tightened to press the free ends of the ring against one another and thereby provide a fluid tight attachment of the bladder 38 to the base. The bladder 38 may be alternatively secured to the base 26 within the scope of the present teachings. For example, the clamp 50 could be constructed as a solid ring without a break. In such a configuration, the clamp 50 may be pressed over the bladder 38 and may be at least partially deformed by hydraulically crimping a portion of the clamp so, for example, once deformed, a portion of the bladder 38 is disposed between the clamp 50 and an upwardly extending portion (FIG. 7) of the base 26.

In either of the foregoing clamp configurations, the upwardly extending portion 49 of the base 26 may include a series of annular protrusions (not shown) to further retain the bladder 38 in contact with the base 26 once the clamp 50 is secured to the bladder 38. The upwardly extending portion 49 may also be tapered such that a distal end of the upwardly extending portion 49 includes a greater cross-sectional area when compared to a proximal end of the upwardly extending portion 49 disposed proximate to and in contact with the base 26 to further prevent removal of the bladder 38 from the base 26.

The second end 41 of the base 26 may define a chamber 56. The chamber 56 may be in fluid communication with an inlet port 58. As shown in simplified form in FIG. 1, the inlet port 58 may be coupled to a source of pressurized air 60 through a hose 62. The source of pressurized air 60 may be an onboard compressor. The inlet port 58 may be internally threaded to receive a fitting 64 for coupling to the hose 62.

The linkage 16 may include one or more spring members. The spring members 16 may conventionally function to normally maintain the wiper 18 in contact with the vehicle windshield. An end of the linkage 16 may be secured to the base 26. For example, a free end of one of the spring members may engage an aperture 43 defined proximate the second end 41 of the base 26.

The bladder 38 may be constructed of rubber. One particular material may including fabric reinforced nitrile. Other materials providing the requisite strength and durability characteristics for the application described herein may alternatively be used. In certain applications and as shown in the drawings, it may be desirable to further include an intermediate member or domed member 66 that fits in a recess 68 defined by the upper surface of the bladder 38. The domed member 66 may be constructed of a substantially rigid plastic and may serve to limit expansion of the elastic bladder 38. The domed member 66 may also function to provide a wiper arm contact surface and thereby reduce wear of the bladder 38 as a result of engagement with the wiper arm 14. The domed member 66 may be constructed of nylon or other suitable material. Alternatively, the domed member 66 may be a discrete part or may be integrally formed with the bladder 38. Domed member 66 transfers immediate motive force. In other applications, the bladder 38 may directly contact the wiper arm 14.

In certain applications and as illustrated in the drawings, it may be desired to provide the wiper arm 14 with a recess or recessed contact surface adjacent the bladder 38. The recess may be concave in shape. The recess may serve to accommodate the bladder 38 in the relaxed position and thereby provide the wiper assembly 10 with an otherwise lower profile. The opposite side of the wiper arm 14 may include a convexly curved surface 70. This convexly curved surface 70 may be provided with trademarks or other identifiers to indicate that the wiper assembly 10 is equipped with wiper technology coming from a particular company source.

In operation, the movement of the wiper arm 14 between the raised and lowered positions can be controlled from the passenger compartment of the vehicle. For example, the movement of the wiper arm 14 may be controlled through the depression of a button 72 (see FIG. 1). The button 72 may be located on the vehicle dash board, proximate the steering column or in any other location convenient to the operator. The source of pressurized air 60 may be delivered to the bladder 38, through a solenoid air gate 57, for inflating the bladder 38 and thereby articulating the wiper arm 14 to the raised position. The solenoid air gate 57 will be understood to be conventional in construction and operation. The solenoid air gate 57 operates between open and closed positions such that when the vehicle ignition key is in the “on” position, the solenoid air gate 57 is open and when the ignition is “off”, solenoid air gate 57 is closed.

Depression of the button 72, pressurizes the bladder 38 and articulates the wiper arm 14 to the raised position. By releasing the button 72, the wiper arm 14 may quickly and forcefully return to the windshield under a conventional biasing force and thereby remove trapped debris. This action may be repeated as desired/necessary to remove ice or other debris. The air pressure may be sufficient to overcome the conventional biasing force of the linkage 16. The air pressure may be controlled to rapidly articulate the wiper arm 14 between the raised and lowered positions.

The system 10 may further be operated to maintain the wiper arm 14 in the raised position for an extended period of time. Such operation may be desired when the vehicle is parked and weather conditions are anticipated that may ice the wiper blades 18 to the windshield. The wiper arm 14 may be placed in the raised position for an extended period of time when the vehicle ignition key is in the “off” position. At this time, the solenoid air gate 57 is closed. Depression of the button 72 serves to inflate the bladder 38. Since the solenoid air gate 57 is closed, the bladder 38 cannot vent and is thereby maintained in the inflated condition. This inflated condition may be maintained overnight. In this manner, the vehicle can be left for extended periods (e.g., overnight) without the risk of the wiper blade freezing to the windshield.

With reference to FIG. 3A, another wiper system in accordance with the present teachings is illustrated and identified at reference character 100. Like reference characters are used to identify similar elements to those introduced above. The wiper system 100 differs from the wiper system 10 in that an underside of the wiper arm 14 includes a downwardly extending portion 102 received within the recess 68 of the bladder 38. The portion 102 may be integrally formed with the wiper arm 14 or secured to the wiper arm 14.

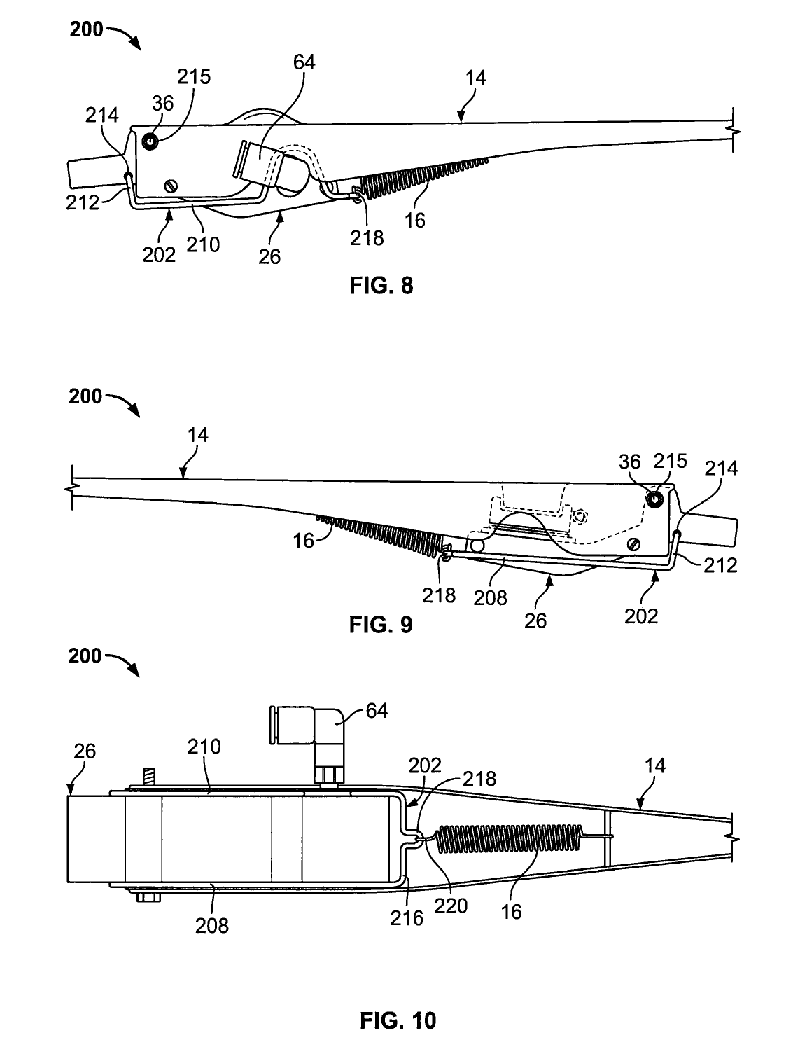

With reference to FIGS. 8-13, another wiper system in accordance with the present teachings is illustrated and identified at reference character 200. Like reference characters are used to identify similar elements to those introduced above.

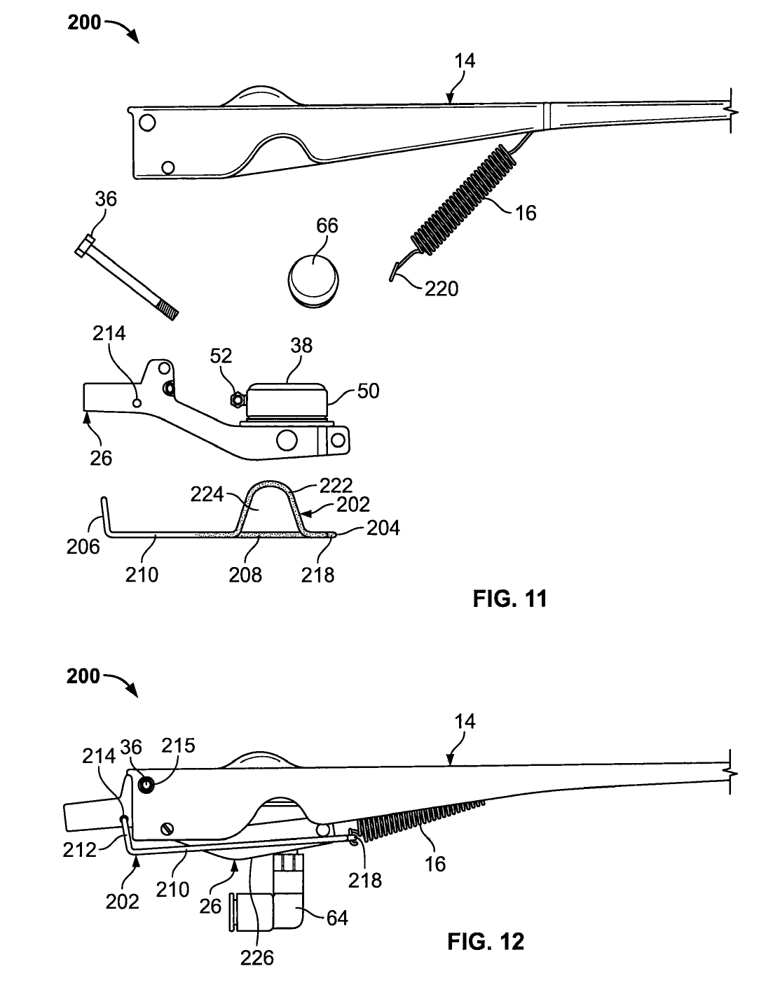

The wiper system 200 may include a bracket 202 extending from a portion of the base 26 proximate to the output shaft 20 to the second end 41 of the base 26. In one configuration, the bracket 202 is formed from a wire and may be bent or otherwise deformed into the structure shown in FIG. 11.

The bracket 202 may include a first end 204, a second end 206, and a pair of arms 208, 210 extending generally between the first end 204 and the second end 206. The first end 204 may include a pair of posts 212 respectively extending from each arm 208, 210. The posts 212 may be rotatably received within a respective aperture 214 formed into the base 26. While the base 26 is described as including a pair of apertures 214 rotatably receiving the posts 212 of the bracket 202, the base 26 could alternatively include a single through bore extending across a width of the base 26, whereby each end of the bore rotatably receives a respective post 212 of the bracket 202 to permit the bracket 202 to be rotatable relative to the base 26.

Regardless of the particular construction of the apertures 214 (i.e., individual apertures or a single bore formed through the base 26), the location of the apertures 214 may be such that each aperture 214 is disposed below a pivot point 215 of the wiper arm 14 relative to the base 26 (identified by fastener 36) and generally between the pivot point 215 and the output shaft 20. Positioning the apertures 214 below the pivot point 215 of the wiper arm 14 and generally between the pivot point 215 and the output shaft 20 locates each aperture 214 below and rearward of the pivot point 215 such that each aperture 214 is disposed closer to the output shaft 20 than is the pivot point 215 of the wiper arm 14. In other words, the pivot point 215 is disposed generally between the apertures 214 and the linkage 16 in a direction substantially parallel to a longitudinal axis of the base 26.

In one configuration, the apertures 214 are located at approximately a forty-degree (40°) angle relative to an axis that extends both through the pivot point 215 and substantially perpendicular to a longitudinal axis of the wiper arm 14. As such, when the posts 212 of the bracket 202 are rotatably received within the respective apertures 214, the bracket 202 includes a pivot point that is both below and rearward of the pivot point 215 of the wiper arm 14.

The second end 206 is disposed at an opposite end of the bracket 202 from the first end 204 and may include a cross member 216 (FIG. 10) joining the arms 208, 210. The cross member 216 may include a spring seat 218 (FIG. 12) that is attached to one end of the linkage 16. In one configuration, the cross member 216 is deformed such that the spring seat 218 extends generally from the cross member 216. In another configuration, a portion of the cross member 216 is twisted to cause a loop to be formed generally near a mid-portion of the cross member 216, whereby the loop forms the spring seat 218 and provides a location for attachment to the linkage 16. As described above, the linkage 16 may be a biasing member such as a spring. As such, the linkage 16 may include an extension 220 that is received within the spring seat 218 to couple the linkage 16 to the base 26 via the bracket 202.

Regardless of the particular construction of the spring seat 218, a portion of each arm 208, 210, the cross member 216, and the spring seat 218 may all include a coating 222 (FIG. 11). The coating 222 may be applied to the second end 206 of the bracket 202 by submerging the bracket 202 in a liquid solution such as, for example, nylon or plastic. The coating 222—once cured and hardened—prevents the bracket 202 from creating noise when the bracket 202 contacts the wiper arm 14.

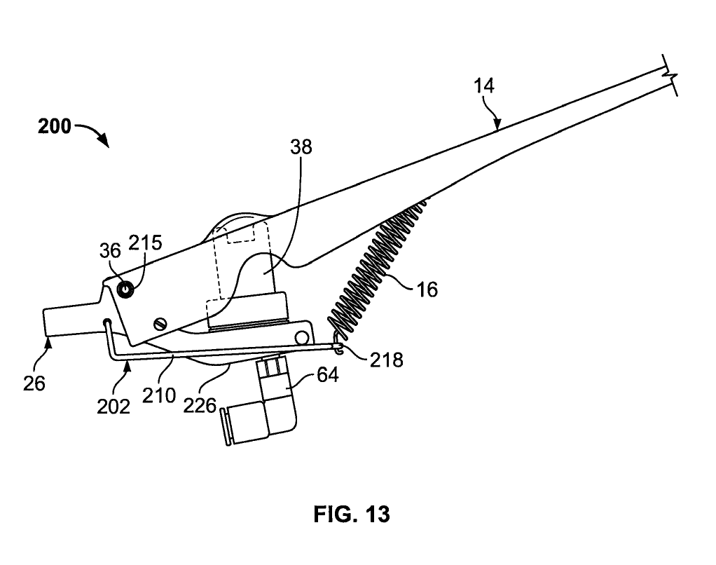

The arm 208 may extend generally between the first end 204 and the second end 206 of the bracket 202 and may include a substantially constant shape along its length (FIG. 8). The arm 210 may likewise extend between the first end 204 and the second end 206 of the bracket 202 but may include a clearance feature 224 that allows the arm 210 to avoid contact with the fitting 64 (FIG. 9). While the arm 210 is described as including a clearance feature 224, the arm 210 may include a substantially constant shape along its length. For example, if the fitting 64 extends from a different surface of the base 26 such as, for example, a bottom surface 226, the arm 210 may include a substantially constant shape, as shown in FIGS. 12 and 13. If the fitting 64 is disposed on the bottom surface 226, each arm 208, 210 may include a similar—if not identical—construction, whereby each arm 208, 210 includes a constant shape along a length of each arm 208, 210.

With particular reference to FIGS. 8-13, operation of the wiper system 200 will be described in detail. When the wiper system 200 is in the position shown in FIG. 8, the wiper arm 14 is positioned such that the wiper blade 18 (FIG. 1) is in contact with the windshield. When the bladder 38 is expanded and the wiper arm 14 is raised (FIG. 13), thereby causing the wiper blade 18 to be removed from the windshield, a force is exerted on the linkage 16. The linkage 16 opposes rotation of the wiper arm 14 from the position shown in FIG. 8 to the position shown in FIG. 13 and, as such, when the bladder 38 exerts a force on the wiper arm 14 causing the wiper arm 14 to move from the lowered position (FIG. 8) to the raised position (FIG. 13), the force must be sufficient enough to overcome the bias imparted on the wiper arm 14 by the linkage 16.

When the force exerted on the wiper arm 14 via the bladder 38 is sufficient to overcome the biasing force of the linkage 16, the wiper arm 14 may be rotated into the raised position from the lowered position, thereby causing the linkage 16 to expand and apply a force on the bracket 202. Specifically, because the extension 220 of the linkage 16 is attached to the spring seat 218, the applied force on the bracket 202 in conjunction with rotation of the wiper arm 14 from the lowered position to the raised position, likewise causes the bracket 202 to rotate relative to the base 26.

Rotation of the bracket 202 relative to the base 26 is accomplished by permitting rotation of each post 212 of the bracket 202 within the apertures 214 formed in the base 26. Because the extension 220 of the linkage 16 is attached to the spring seat 218 of the bracket 202, the posts 212 effectively act as the pivot point for the linkage 16. Positioning the pivot point of the linkage 16 at the apertures 214 of the base 26 provides the wiper arm 14 with the ability to be rotated approximately ninety degrees (90°) from the lowered position to the raised position. Furthermore, allowing the pivot point of the linkage 16 to be disposed at the apertures 214 allows the force applied to the wiper arm 14 via the bladder 38 to be linear such that the force required to overcome the bias imparted on the wiper arm 14 by the linkage 16 does not increase as the wiper arm 14 is rotated farther from the lowered position and toward the raised position.

When the force exerted on the wiper arm 14 via the bladder 38 is exhausted, the linkage 16 once again applies a force on the wiper arm 14 due to interaction between the linkage 16 and the wiper arm 14 and interaction between the linkage 16 and the base 26 via the bracket 202. Specifically, the linkage 16 contracts, thereby causing the wiper arm 14 to rotate about fastener 36 and concurrently causes the bracket 202 to rotate about the posts 212 within apertures 214. Once the wiper blade 18 contacts the windshield, the linkage 16 is prevented from further rotating the wiper arm 14 relative to the base 26 and the wiper system 200 is returned to the lowered position, whereby the wiper blade 18 is in contact with the windshield.

With any of the foregoing wiper systems 10, 100, 200, the motor 22 and/or bladder 38 may be actuated a predetermined number of times over a predetermined time period when a vehicle is not in use. For example, the motor 22 may be actuated four to five times per hour to keep the windshield free from debris while the operator of the vehicle is not present. In addition or alternatively, the bladder 38 may be inflated when the operator of the vehicle is not present to move the wiper arm 14 into the raised position to prevent the wiper blade 18 from freezing or otherwise sticking to the windshield. For example, the bladder 38 may be inflated four to five times per hour to periodically lift the wiper blade 18 from the windshield. This way, when the operator returns to the vehicle, the windshield is free from debris and does not require scraping and the wiper system 10, 100, 200 is ready for use.

The description of the present teachings are merely exemplary in nature and, thus, variations that do not depart from the gist of the invention are intended to be within the scope of the invention. Such variations are not to be regarded as a departure from the spirit and scope of the invention.

What is claimed is:

1. A wiper system for use with a windshield, the wiper system comprising:
a housing;
a wiper arm rotatably supported by said housing about a first pivot point between a first position proximate to the windshield and a second position raised from the windshield;
a separator assembly coupled to the housing and operable to selectively move said wiper arm from said first position to said second position;
a biasing member biasing said wiper arm in said first position; and
a bracket extending from said housing to said biasing member to rotatably couple said biasing member to said housing at a second pivot point.

2. The wiper system of claim 1, wherein said second pivot point is below said first pivot point.

3. The wiper system of claim 1, wherein said first pivot point is disposed between said second pivot point and said biasing member in a direction substantially parallel to a longitudinal axis of said housing.

4. The wiper system of claim 1, wherein said second pivot point is disposed farther away from said biasing member than said first pivot point and is disposed below said first pivot point.

5. The wiper system of claim 1, wherein said bracket is rotatably coupled to said housing at a first end and attached to said biasing member at a second end.

6. The wiper system of claim 5, wherein said bracket includes a spring seat at said second end for attachment to said biasing member.

7. The wiper system of claim 5, wherein said bracket includes a first arm extending between said first end and said second end and a second arm extending between said first end and said second end.

8. The wiper system of claim 7, wherein said housing is disposed between said first arm and said second arm.

9. The wiper system of claim 1, wherein said separator assembly selectively engages said wiper arm to move said wiper arm from said first position to said second position.

10. The wiper system of claim 1, wherein said separator assembly includes at least one inflatable bladder movable from a relaxed state to an inflated state, said at least one bladder applying a force on said wiper arm in said inflated state to move said wiper arm from said first position to said second position.

11. A wiper system for use with a windshield, the wiper system comprising:
a housing;
a wiper arm rotatably supported by said housing between a first position proximate to the windshield and a second position raised from the windshield;
a separator assembly coupled to the housing and operable to selectively move said wiper arm from said first position to said second position;
a biasing member biasing said wiper arm in said first position; and
a bracket rotatably coupled to said housing at a first end and attached to said biasing member at a second end.

12. The wiper system of claim 11, wherein said wiper arm rotates about a first pivot point and said first end of said bracket rotates about a second pivot point different than said first pivot point.

13. The wiper system of claim 12, wherein said second pivot point is below said first pivot point.

14. The wiper system of claim 12, wherein said first pivot point is disposed between said second pivot point and said biasing member in a direction substantially parallel to a longitudinal axis of said housing.

15. The wiper system of claim 12, wherein said second pivot point is disposed farther away from said biasing member than said first pivot point and is disposed below said first pivot point.

16. The wiper system of claim 11, wherein said bracket includes a spring seat at said second end for attachment to said biasing member.

17. The wiper system of claim 11, wherein said bracket includes a first arm extending between said first end and said second end and a second arm extending between said first end and said second end.

18. The wiper system of claim 17, wherein said housing is disposed between said first arm and said second arm.

19. The wiper system of claim 11, wherein said separator assembly selectively engages said wiper arm to move said wiper arm from said first position to said second position.

20. The wiper system of claim 11, wherein said separator assembly includes at least one inflatable bladder movable from a relaxed state to an inflated state, said at least one bladder applying a force on said wiper arm in said inflated state to move said wiper arm from said first position to said second position.
